(19) United States
(12) Patent Application Publication
(10) Pub. No.: US 2018/0018296 A1
(43) Pub. Date: Jan. 18, 2018

(54) FLOW CONTROL PROTOCOL FOR AN AUDIO BUS

(71) Applicant: QUALCOMM Incorporated, San Diego, CA (US)

(72) Inventor: Lior Amarilio, Yokneam (IL)

(21) Appl. No.: 15/632,519

(22) Filed: Jun. 26, 2017

Related U.S. Application Data
(60) Provisional application No. 62/362,116, filed on Jul. 14, 2016.

(51) Int. Cl. G06F 13/42; G06F 3/16

(52) U.S. Cl. CPC G06F 13/4282; G06F 3/162

(57) ABSTRACT

A flow control protocol for an audio bus is disclosed. In an exemplary aspect, an audio source may push content to an audio sink over one or more cascaded audio bus segments or links. The audio source will send an indication to the audio sink that data is coming, and the audio sink should manipulate the data accordingly. Conversely, the audio source may also send an indication to the audio sink that, in a particular sample-event in a particular future sample-window, no data is present and the audio sink may disregard any bits in the corresponding sample-event. In another exemplary aspect, the audio sink may request data from the audio source with a receive ready indication. The audio source then sends data in a corresponding time slot for processing by the audio sink. Likewise, the audio sink may provide an indication that the audio sink cannot accept more data through a negative receive ready indication.

### PRIORITY CLAIM

The present application claims priority to U.S. Provisional Patent Application Ser. No. 62/362,116, filed on Jul. 14, 2016 and entitled “FLOW CONTROL PROTOCOL FOR SOUNDWIRE-XL BUS,” the contents of which is incorporated herein by reference in its entirety.

### BACKGROUND

### I. Field of the Disclosure

The technology of the disclosure relates generally to an audio bus, and more particularly to the SOUNDWIRE audio bus, and still more particularly to the SOUNDWIRE-XL audio bus.

### II. Background

Mobile terminals have become increasingly common in modern society. These devices have evolved from large, clunky, relatively simple telephonic devices to small, full range, multimedia devices with vastly improved processing power. The early mobile terminals generally provided poor sound quality and little, if any, visual image capacity. As the processing power for these mobile terminals has increased and the range of multimedia options has increased, the quality of the possible audio experience has likewise increased. In particular, contemporaneous mobile terminals may include multiple speakers, multiple microphones and, optionally, may communicate with remote audio devices such as headsets.

The MIPI® Alliance introduced the Serial Low Power Inter-chip Media Bus (SLIMbus®) protocol to help standardize communication between audio elements of a mobile terminal. While effective at providing communication between the audio elements of the mobile terminal, SLIMbus has not seen widespread acceptance by the industry. Accordingly, the MIPI Alliance has introduced the SOUNDWIRE specification to provide an alternative or supplement to the SLIMbus protocol.

The SOUNDWIRE specification provides for a two-wire communication bus that may not exceed fifty centimeters (50 cm) in length. While such distances are readily satisfied for the audio elements within the mobile terminal, such distances may be too short for some regularly used ancillary devices such as a headset. Accordingly, MIPI has proposed SOUNDWIRE-XL, which, as of this writing is at version 0.1 revision 1, published Jun. 8, 2016. While effective at allowing communication over greater distances, SOUNDWIRE-XL still faces challenges in making sure that audio sources and audio sinks send a proper amount of data and examine appropriate bit slots for audio. Absent such controls, audio quality may be degraded. Accordingly, there is a need for better control of when and where data is placed in a time slot so that the data is read appropriately.

### SUMMARY OF THE DISCLOSURE

Aspects disclosed in the detailed description include a flow control protocol for an audio bus. In an exemplary aspect, an audio source may push content to an audio sink over one or more cascaded audio bus segments or links. The audio source will send an indication to the audio sink that data is coming, and the audio sink should manipulate the data accordingly. Conversely, the audio source may also send an indication to the audio sink that, in a particular sample-event in a particular future sample-window, no data is present and the audio sink may disregard any bits in the corresponding sample-event. In another exemplary aspect, the audio sink may request data from the audio source with a receive ready indication. The audio source then sends data in a corresponding time slot for processing by the audio sink. Likewise, the audio sink may provide an indication that the audio sink cannot accept more data through a negative receive ready indication. In such instance, the audio source does not send data in the corresponding time slot and the audio sink does not try to process any bits in that corresponding time slot. In still another exemplary aspect, both transmit ready indications and receive ready indications may be exchanged. By providing such indications (according to any of the aforementioned aspects), the audio sink manipulates only valid data and does not try to manipulate noise that may be present when data is not sent. Elimination of such extraneous manipulation improves the audio experience.

In this regard in one aspect, a method of controlling a SOUNDWIRE-XL bus is disclosed. The method includes, at an audio source, populating a signal with at least one Txready bit. When the at least one Txready bit is valid, the method also includes populating the signal with valid audio data at a corresponding location. When the at least one Txready bit is invalid, the method also includes leaving the corresponding location empty. The method also includes sending the signal over a SOUNDWIRE-XL bus.

In another aspect, an audio source is disclosed. The audio source includes a downstream-facing interface configured to couple to a SOUNDWIRE-XL audio bus. The audio source also includes a control system. The control system is configured to populate a signal with at least one Txready bit. When the at least one Txready bit is valid, the control system is configured to populate the signal with valid audio data at a corresponding location. When the at least one Txready bit is invalid, the control system is configured to leave the corresponding location empty. The control system is also configured to send the signal over the SOUNDWIRE-XL audio bus.

In another aspect, an audio source is disclosed. The audio source includes a downstream-facing interface configured to couple to a multi-segment audio bus. The audio source also includes a control system. The control system is configured to populate a signal with at least one Txready bit. When the at least one Txready bit is valid, the control system is configured to populate the signal with valid audio data at a corresponding location. When the at least one Txready bit is invalid, the control system is configured to leave the corresponding location empty. The control system is also configured to send the signal over the multi-segment audio bus.

In another aspect, a method of controlling a multi-segment audio bus is disclosed. The method includes, at an audio source, populating a signal with at least one Txready bit. When the at least one Txready bit is valid, the method also includes populating the signal with valid audio data at a corresponding location. When the at least one Txready bit is invalid, the method also includes leaving the corresponding location empty. The method also includes sending the signal over a multi-segment audio bus.

In another aspect, a method of controlling a SOUNDWIRE-XL bus is disclosed. The method includes, at an audio sink, receiving a signal from a SOUNDWIRE-XL bus. The method also includes evaluating a Txready bit within the signal. When the Txready bit is valid, the method also includes reading audio data from corresponding bit slots in the signal. When the Txready bit is invalid, the method also includes ignoring data from the corresponding bit slots.

In another aspect, an audio sink is disclosed. The audio sink includes an upstream-facing interface configured to be coupled to a SOUNDWIRE-XL bus. The audio sink also includes a control system. The control system is configured to evaluate a Txready bit within a signal received from the SOUNDWIRE-XL bus. When the Txready bit is valid, the control system is configured to read audio data from corresponding bit slots in the signal. When the Txready bit is invalid, the control system is configured to ignore data from the corresponding bit slots.

In another aspect, an audio sink is disclosed. The audio sink includes an upstream-facing interface configured to be coupled to a multi-segment audio bus. The audio sink also includes a control system. The control system is configured to evaluate a Txready bit within a signal received from the multi-segment audio bus. When the Txready bit is valid, the control system is configured to read audio data from corresponding bit slots in the signal. When the Txready bit is invalid, the control system is configured to ignore data from the corresponding bit slots.

In another aspect, a method of controlling a multi-segment audio bus is disclosed. The method includes, at an audio sink, receiving a signal from a multi-segment audio bus. The method also includes evaluating a Txready bit within the signal. When the Txready bit is valid, the method also includes reading audio data from corresponding bit slots in the signal. When the Txready bit is invalid, the method also includes ignoring data from the corresponding bit slots.

In another aspect, a method of controlling a SOUNDWIRE-XL bus is disclosed. The method includes determining if an audio sink will have room for data. The method also includes sending an Rxready bit to an audio source where the Rxready bit is valid if there is room for the data and invalid if there is not room for the data. The method also includes receiving a corresponding signal from the audio source. When the audio sink sends an Rxready valid bit, the method also includes reading audio data from the corresponding signal. When the audio sink sends an Rxready invalid bit, the method also includes disregarding the data from the corresponding signal.

In another aspect, an audio sink is disclosed. The audio sink includes an upstream-facing interface configured to be coupled to a SOUNDWIRE-XL bus. The audio sink also includes a buffer. The audio sink also includes a control system. The control system is configured to determine if the buffer will have room for data. The control system is also configured to send an Rxready bit to an audio source where the Rxready bit is valid if there is room for the data and invalid if there is not room for the data. The control system is also configured to receive a corresponding signal from the audio source. When the audio sink sends an Rxready valid bit, the control system is configured to read audio data from the corresponding signal. When the audio sink sends an Rxready invalid bit, the control system is configured to disregard the data from the corresponding signal.

In another aspect, a method of controlling a SOUNDWIRE-XL bus is disclosed. The method includes, at an audio source, receiving a signal from an audio sink. The method also includes reading an Rxready bit in the signal from the audio sink. When the Rxready bit is valid, the method also includes populating a second signal with valid data and sending the second signal to the audio sink. When the Rxready bit is invalid, the method also includes sending the second signal with empty bit slots instead of the valid data to the audio sink.

In another aspect, a method of controlling a multi-segment audio bus is disclosed. The method includes, at an audio source, receiving a signal from an audio sink across a multi-segment audio bus. The method also includes reading an Rxready bit in the signal from the audio sink. When the Rxready bit is valid, the method also includes populating a second signal with valid data and sending the second signal to the audio sink across the multi-segment audio bus. When the Rxready bit is invalid, the method also includes sending the second signal with empty bit slots instead of the valid data to the audio sink.

In another aspect, an audio source is disclosed. The audio source includes a downstream-facing interface configured to couple to a multi-segment audio bus. The audio source also includes a control system. The control system is configured to receive a signal from an audio sink across the multi-segment audio bus. The control system is also configured to read an Rxready bit in the signal from the audio sink. When the Rxready bit is valid, the control system is configured to populate a second signal with valid data and send the second signal to the audio sink across the multi-segment audio bus. When the Rxready bit is invalid, the control system is configured to send the second signal with empty bit slots instead of the valid data to the audio sink.

In another aspect, an audio source is disclosed. The audio source includes a downstream-facing interface configured to couple to a SOUNDWIRE-XL bus. The audio source also includes a control system. The control system is configured to receive a signal from an audio sink across the SOUNDWIRE-XL bus. The control system is also configured to read an Rxready bit in the signal from the audio sink. When the Rxready bit is valid, the control system is configured to populate a second signal with valid data and send the second signal to the audio sink across the SOUNDWIRE-XL bus. When the Rxready bit is invalid, the control system is configured to send the second signal with empty bit slots instead of the valid data to the audio sink.

In another aspect, an audio sink is disclosed. The audio sink includes an upstream-facing interface configured to be coupled to a multi-segment audio bus. The audio sink also includes a buffer. The audio sink also includes a control system. The control system is configured to determine if the buffer will have room for data. The control system is also configured to send an Rxready bit to an audio source where the Rxready bit is valid if there is room for the data and invalid if there is not room for the data. The control system is also configured to receive a corresponding signal from the audio source. When the audio sink sends an Rxready valid bit, the control system is configured to read audio data from the corresponding signal. When the audio sink sends an Rxready invalid bit, the control system is configured to disregard the data from the corresponding signal.

In another aspect, a method of controlling a multi-segment audio bus is disclosed. The method includes determining if an audio sink will have room for data. The method also includes sending an Rxready bit to an audio source where the Rxready bit is valid if there is room for the data and invalid if there is not room for the data. The method also includes receiving a corresponding signal from the audio source. When the audio sink sends an Rxready valid bit, the method also includes reading audio data from the corresponding signal. When the audio sink sends an Rxready invalid bit, the method also includes disregarding the data from the corresponding signal.

### BRIEF DESCRIPTION OF THE FIGURES

FIG. 1 is a block diagram of an exemplary conventional SOUNDWIRE system with a bus;

FIG. 2 is a block diagram of a SOUNDWIRE-XL system with both a SOUNDWIRE bus and a SOUNDWIRE-XL bus;

FIG. 3 is a block diagram of cascaded SOUNDWIRE-XL segments in an expanded SOUNDWIRE-XL system that may benefit from exemplary aspects of the present disclosure;

FIG. 4 is a flowchart of an exemplary aspect of the present disclosure where an audio source pushes data to an audio sink;

FIG. 5 is a signal flow diagram showing signaling that may occur over a cascaded SOUNDWIRE-XL system when implementing the method of FIG. 4;

FIG. 6 is a flowchart of an exemplary aspect of the present disclosure where an audio sink requests data from an audio source and is provided same;

FIG. 7 is a signal flow diagram showing signaling that may occur over a cascaded SOUNDWIRE-XL system when implementing the method of FIG. 6;

FIG. 8 illustrates an exemplary aspect of the present disclosure using two bits; and

FIG. 9 is a block diagram of an exemplary processor-based system that can include the expanded SOUNDWIRE-XL system of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a flow control protocol for an audio bus. In an exemplary aspect, an audio source may push content to an audio sink over one or more cascaded audio bus segments or links. The audio source will send an indication to the audio sink that data is coming, and the audio sink should manipulate the data accordingly. Conversely, the audio source may also send an indication to the audio sink that, in a particular sample-event in a particular future sample-window, no data is present and the audio sink may disregard any bits in the corresponding sample-window. In another exemplary aspect, the audio sink may request data from the audio source with a receive ready indication. The audio source then sends data in a corresponding time slot for processing by the audio sink. Likewise, the audio sink may provide an indication that the audio sink cannot accept more data through a negative receive ready indication. In such instance, the audio source does not send data in the corresponding time slot and the audio sink does not try to process any bits in that corresponding time slot. In still another exemplary aspect, both transmit ready indications and receive ready indications may be exchanged. By providing such indications (according to any of the aforementioned aspects), the audio sink manipulates only valid data and does not try to manipulate noise that may be present when data is not sent. Elimination of such extraneous manipulation improves the audio experience.

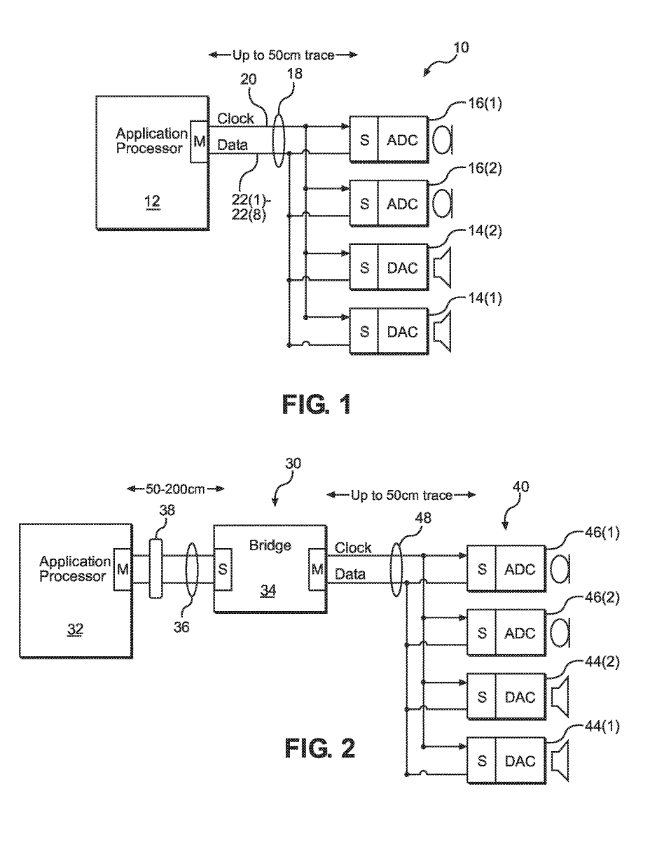

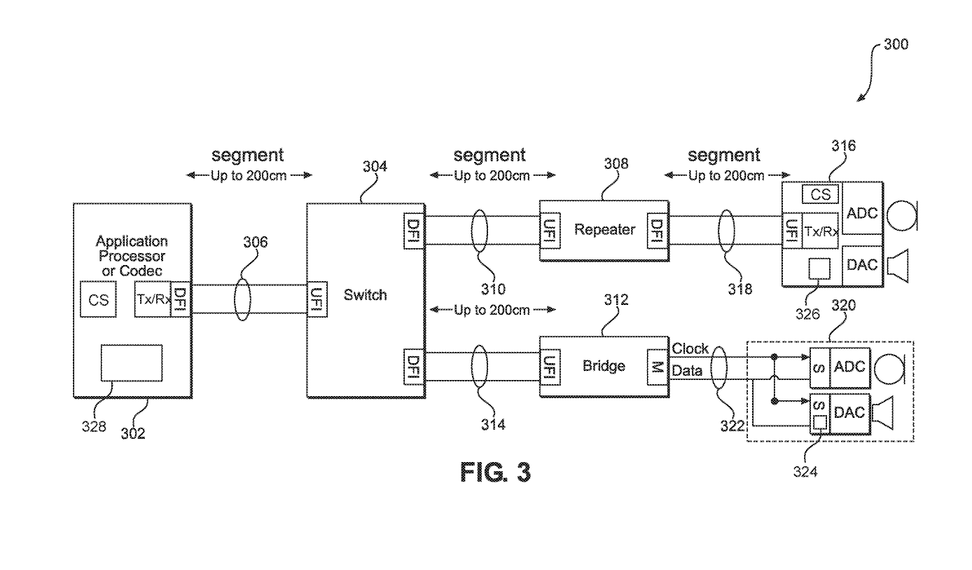

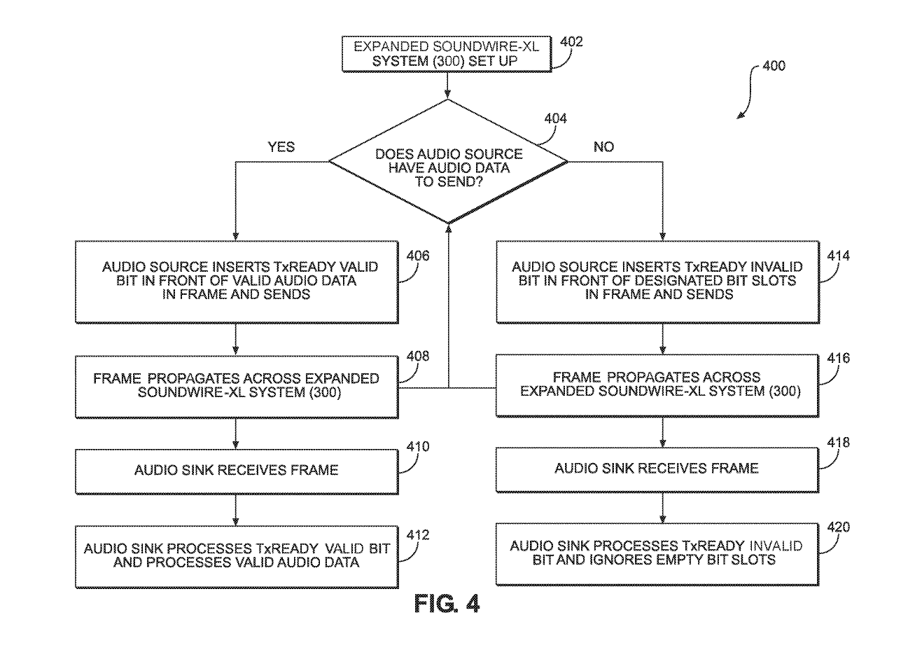

Before addressing particular exemplary aspects of the present disclosure, a brief overview of a SOUNDWIRE system is provided with reference to FIG. 1, and a brief overview of a SOUNDWIRE-XL system is provided with reference to FIG. 2. An overview of a cascaded SOUNDWIRE-XL system that may benefit from exemplary aspects of the present disclosure is provided with reference to FIG. 3, while a discussion of how to implement exemplary aspects of the present disclosure begins below with reference to FIG. 4. While the present disclosure is well-suited for use with SOUNDWIRE-XL, and the examples provided herein are SOUNDWIRE-XL specific, it should be appreciated that other multi-segment audio buses may also benefit from the present disclosure, and the present disclosure is not specifically limited to a SOUNDWIRE-XL environment.

In this regard, FIG. 1 is block diagram of an exemplary conventional SOUNDWIRE system 10. The SOUNDWIRE system 10 includes an application processor 12 coupled to a plurality of microphones 14(1)-14(2) and a plurality of speakers 16(1)-16(2) by a multi-wire bus 18. The multi-wire bus 18 includes a clock line 20 and one or more (up to eight) data lines 22(1)-22(8). The application processor 12 is generally regarded as a master of the SOUNDWIRE system 10, and the plurality of microphones 14(1)-14(2) and the plurality of speakers 16(1)-16(2) (as well as any other audio components) are slaves. While illustrated as the application processor 12, it should be appreciated that the application processor 12 could be replaced by a codec (not illustrated) or similar element. The multi-wire bus 18 is limited by the SOUNDWIRE specification to less than 50 centimeters (cm). More information on the SOUNDWIRE specification may be found at Specification for SOUNDWIRE, version 1, released Jan. 21, 2015, available at members.mipi.org/wg/LML/document/folder/8154 to MIPI members. The SOUNDWIRE specification is incorporated by reference in its entirety. As noted, the limit of 50 cm on the length of the multi-wire bus 18 may negatively affect the ability to use certain devices such as a headset with a mobile terminal.

The SOUNDWIRE specification defines a configurable frame having multiple lanes (up to eight). In practice, each lane is assigned to one of the one or more data lines 22(1)-22(8) of the multi-wire bus 18. The frame has rows and columns. In each row, bit slots are provided that may change from any source to any other source. It should be appreciated that having a bus turnaround for each bit slot provides the possibility of flow control transport per each sample-event, although there is an overhead penalty associated with frequent turnaround.

Exemplary aspects of the SOUNDWIRE-XL disclosure, currently being promulgated by MIPI allow the length of the multi-wire bus between the application processor and the end elements to be extended beyond the current 50 cm maximum length. The SOUNDWIRE-XL disclosure does not allow for flow control transport per each sample-event because of the overhead penalty that would be incurred. Rather, the SOUNDWIRE-XL disclosure provides a protocol that does not suffer from a high overhead associated with bus turnaround by concatenating the transmit bits together and the receive bits together. In particular, MIPI has proposed SOUNDWIRE-XL, which, as of this writing, is at version 0.1 revision 1, published Jun. 8, 2016, which is hereby incorporated by reference in its entirety. MIPI members may access this document through the MIPI website. In this regard, FIG. 2 is a block diagram of a SOUNDWIRE-XL system 30 enabling long distance connections. The SOUNDWIRE-XL system 30 includes an application processor 32 coupled to a bridge 34 by a long cable 36. The long cable 36 and other long cables described herein are sometimes referred to as digital audio cables. It should be appreciated that the application processor 32 may instead be a codec. In an exemplary aspect, the long cable 36 is expected to be greater than 50 cm (although it can be shorter and still work with exemplary aspects of the present disclosure), but less than two meters (2 m), and may use a 3.5 mm audio jack (not illustrated), a Universal Serial Bus (USB) connector 38 (e.g., Type-C or micro-USB), or other proprietary type of cable or connector. The bridge 34 acts like a master for a SOUNDWIRE sub-system 40. The SOUNDWIRE sub-system 40 may include a plurality of microphones 44(1)-44(2) and a plurality of speakers 46(1)-46(2) (as well as any other audio components) that are slaves within the SOUNDWIRE sub-system 40. In an exemplary aspect, the SOUNDWIRE sub-system 40 may be instantiated in a headset (not illustrated). The bridge 34 may include a control system (not illustrated) that enables signal conversion between the long cable 36 and the SOUNDWIRE sub-system 40. The bridge 34 is coupled to the plurality of microphones 44(1)-44(2) and the plurality of speakers 46(1)-46(2) via a multi-wire bus 48 that is compliant with the SOUNDWIRE specification (i.e., multi-wire bus, including a clock line and one or more data lines, and less than 50 cm). In an exemplary aspect, the long cable 36 uses a SOUNDWIRE-XL protocol described below, and the bridge 34 converts messages in the SOUNDWIRE-XL protocol from the application processor 32 to a SOUNDWIRE protocol and converts messages in the SOUNDWIRE protocol from the SOUNDWIRE sub-system 40 to the SOUNDWIRE-XL protocol. It should also be appreciated that the application processor 32 may be a native SOUNDWIRE element and may operate with SOUNDWIRE-XL through a protocol conversion using an internal bridge (not illustrated in FIG. 2) or directly populate signals using SOUNDWIRE-XL.

SOUNDWIRE-XL defines a frame having a number of rows equal to a number of rows in SOUNDWIRE, and a number of columns equal to a number of columns in SOUNDWIRE multiplied by a number of lanes in SOUNDWIRE. Further, sub-frames in SOUNDWIRE are organized such that payload data from all lanes are in one row. Still further, all transmission (Tx) bit slots are concatenated into one group and all receipt (Rx) bit slots are concatenated into a second group.

It should be appreciated that SOUNDWIRE-XL allows for cascaded or multi-segment SOUNDWIRE-XL elements to support even longer distances. It should be appreciated that cascaded elements increase the propagation delay, and have a corresponding longer bus turnaround. However, the point-to-point interface still allows for high bandwidth utilization with additional levels of repeaters and hubs. For example, a digital audio cable may extend from a first computing device to a hub, and a headset plugged into the hub. Both the connection from the primary computing device to the hub and the connection from the hub to the headset may be SOUNDWIRE-XL compliant with a bridge inside the headset converting the SOUNDWIRE-XL compliant signals to SOUNDWIRE compliant signals. Still other use cases may exist. For the sake of illustration, FIG. 3 provide a hypothetical, non-limiting block diagram of cascaded SOUNDWIRE-XL segments in an expanded SOUNDWIRE-XL system 300 that may benefit from exemplary aspects of the present disclosure.

In this regard, the expanded SOUNDWIRE-XL system 300 may include an application processor 302 coupled to a switch 304 through a first segment SOUNDWIRE-XL cable 306. As noted above, the application processor 302 may be a codec or other master style device. In an exemplary aspect, the application processor 302 may be an audio source. The switch 304 may be coupled to a repeater 308 through a first second segment SOUNDWIRE-XL cable 310. The switch 304 may further be coupled to a bridge 312 through a second segment SOUNDWIRE-XL cable 314. The repeater 308 may be coupled to a headset 316 through a third segment SOUNDWIRE-XL cable 318. The bridge 312 may support a SOUNDWIRE device 320 through a SOUNDWIRE bus 322. The SOUNDWIRE device 320 may include one or more buffers 324 that receive and hold audio data for audio playback and capture data from a microphone to send to the application processor 302. Similarly, the headset 316 may include one or more buffers 326 that receive and hold audio data for audio playback and capture data from a microphone to send to the application processor 302. To the extent that the application processor 302 may also be an audio sink (e.g., receiving data captured by microphones in the headset 316), the application processor 302 or associated processor may include one or more buffers 328 to hold audio data therefrom. The SOUNDWIRE device 320 may be comparable to the SOUNDWIRE system 10 of FIG. 1 described above. It should be appreciated that other cascaded or multi-segment system topologies are possible and may benefit from exemplary aspects of the present disclosure, and the expanded SOUNDWIRE-XL system 300 is intended to help explain exemplary aspects of the present disclosure without restricting those aspects to a particular system topology.

It should be appreciated that necessary and sufficient control systems (CSs), transceivers (Tx/Rx) and physical layer interfaces (sometimes referred to as downstream-facing interfaces (DFIs) or upstream-facing interface s (UFIs)) are present in the application processor 302 and the headset 316 and the SOUNDWIRE device 320 to send and receive signals across the respective buses. Note that it should be appreciated that the switch 304, repeater 308, and bridge 312 may likewise each include respective DFIs and UFIs coupled with appropriate transmitters and receivers (and/or control systems) to effectuate passing the signals as is well understood.

In many situations the audio sampling rate will not generate sufficient data to fill the frame sent over a SOUNDWIRE-XL segment completely. For example, if the audio sampling rate is the relatively common 44.1 kilohertz (kHz), but the frequency of the audio sample-events over the SOUNDWIRE-XL segment is 48 kHz, then there will be empty time slots. Similar issues exist for another relatively common rate of 88.2 kHz sampling rate and 96 kHz bus frequency. While in the abstract having unused bit slots within a frame should not be a problem, the nature of the SOUNDWIRE-XL protocol assigns those bit slots to an audio sink regardless of whether there is audio data on those bit slots. Thus, the audio sink will continue to read from its designated bit slots and try to interpret the bits therein whether those bits represent valid audio data or random noise. If the audio sink treats random noise as valid audio data, that noise is introduced into the playback and audio quality suffers corresponding degradation.

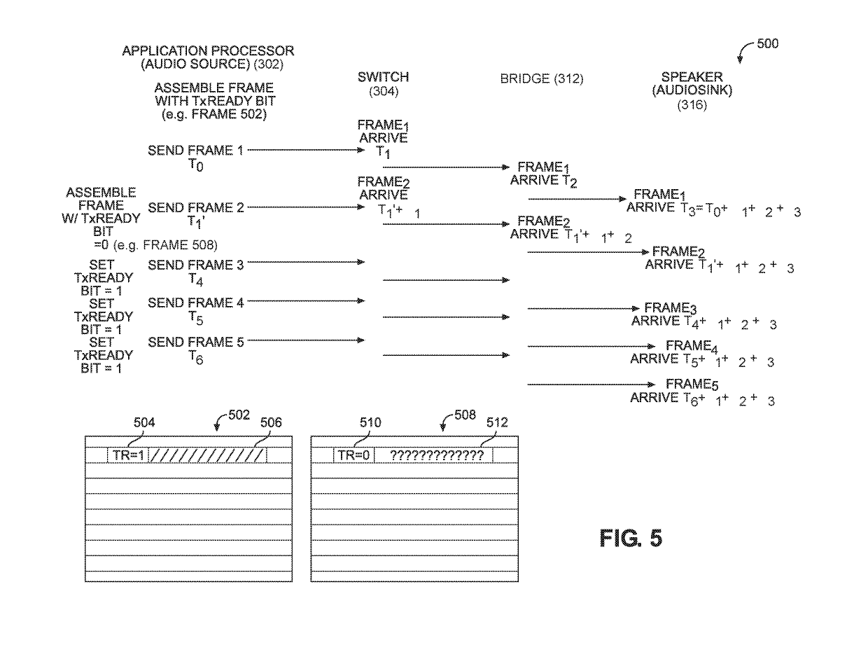

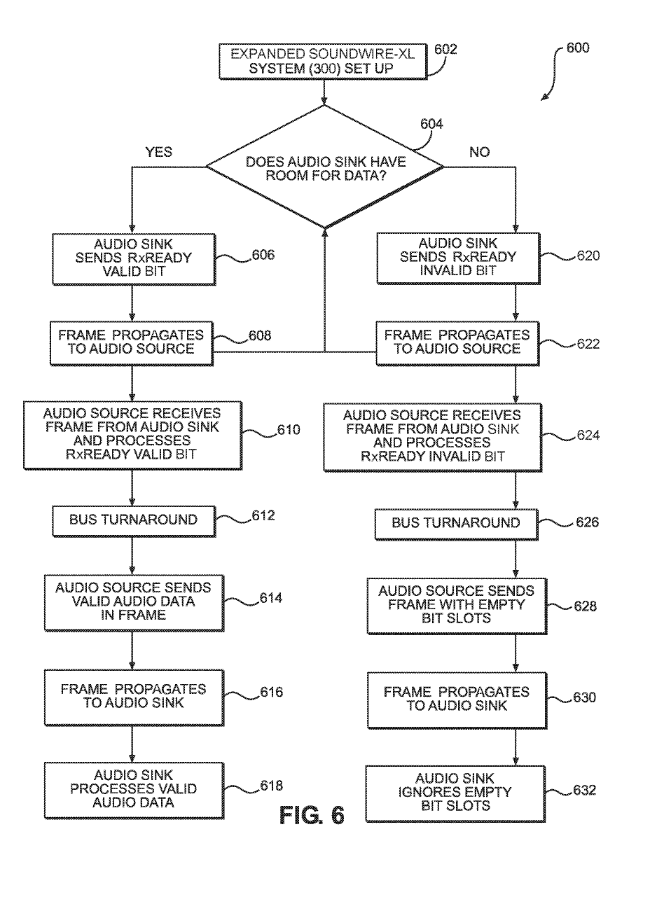

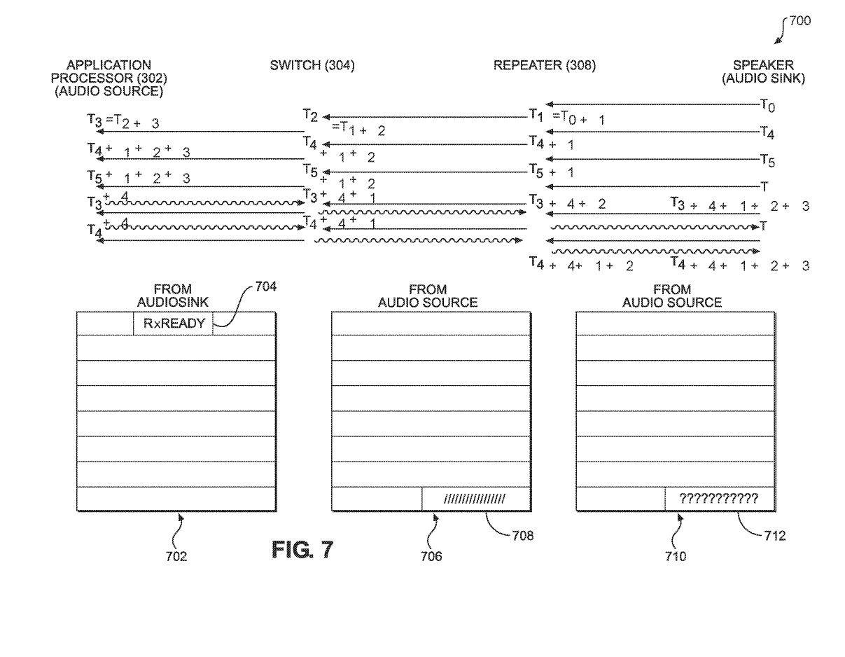

Exemplary aspects of the present disclosure allow the audio sink to know what is intended to be, be informed of what is intended to be, or request that specific data be valid audio data and what is intended to be unused bit slots. Through the use of such knowledge, the audio sink may avoid processing random noise and improve audio quality. Exemplary aspects of the present disclosure contemplate three scenarios including the audio source informing the audio sink that particular data is valid audio data or not; the audio sink requesting that particular upcoming data be valid audio data or not; and shared responsibility from both the audio source and the audio sink to inform the audio sink that particular upcoming data be valid audio data or not. FIGS. 4 and 5 illustrate the aspect where the audio source informs the audio sink while FIGS. 6 and 7 illustrate the aspect where the audio sink requests from the audio source.

In this regard, FIG. 4 illustrates a process 400 where initially the expanded SOUNDWIRE-XL system 300 of FIG. 3 goes through enumeration and other set-up processes as is conventional (block 402) including assigning audio channels to bit slots within a frame and the like. It should be appreciated that the example of the expanded SOUNDWIRE-XL system 300 is a SOUNDWIRE-XL system, exemplary aspects of the present disclosure may be applied to other multi-segment audio buses and the present disclosure is not limited to a SOUNDWIRE-XL system. A frame is better illustrated in FIG. 5 and discussed below in reference thereto. In this example, the application processor 302 of FIG. 3 is the audio source, such as for example, when the application processor 302 is handling a stored audio file for playback on a remote speaker in the headset 316. The audio source determines if it has audio data to send to the audio sink (block 404). If the answer to block 404 is yes, the audio source inserts a Txready valid bit in front of valid audio data in the frame in the appropriate bit slots and sends the frame (block 406). In an exemplary aspect, the Txready valid bit is set to one (1). The frame propagates across the expanded SOUNDWIRE-XL system 300 (block 408) such as passing from the application processor 302, across the first segment SOUNDWIRE-XL cable 306 to the switch 304, and from the switch 304 to the repeater 308 to the headset 316. The audio sink receives the frame (block 410) and processes the Txready valid bit. Note that while the frame is propagating across the expanded SOUNDWIRE-XL system 300, the application processor 302 is also processing the next frame and determining the next Txready bit (designated by the return to block 404). Since the Txready bit is valid, the audio sink processes the valid audio data after the Txready bit (block 412).

With continued reference to FIG. 4, if the answer to block 404 is no, there is no data to send, then the audio source inserts a Txready invalid bit in front of designated bit slots in the frame and sends (block 414). The frame then propagates across the expanded SOUNDWIRE-XL system 300 as described above (block 416). Again, while the frame is propagating, the application processor 302 is also processing the next frame and determining the next Txready bit. The audio sink receives the frame (block 418) and processes the Txready bit. Seeing that the Txready bit is set to invalid, the audio sink ignores the empty bit slots in the frame (block 420). By ignoring the bit slots that do not have valid audio data (i.e., empty), the audio sink does not improperly process noise bits and audio quality is improved.

The signaling associated with the process 400 is illustrated in FIG. 5 where signal flow diagram 500 is presented. As illustrated herein, the frame size is equal to the sample-window size. It should be appreciated that such equality is not required. However, for the sake of simplicity, the following discussion maintains this assumption. In particular, the continuous nature of frame assembly and transmission across the expanded SOUNDWIRE-XL system 300 of FIG. 3 is illustrated. Further, a first frame 502 is provided with a Txready bit 504 set to 1 and valid audio data 506 immediately following the Txready bit 504. When the first frame 502 arrives at the audio sink, the audio sink knows to look at the bit slot containing the Txready bit 504. Seeing that the Txready bit 504 is set to valid (e.g., 1), the audio sink then processes the data in the bit slots assigned to the audio sink in the first frame 502. In the example, those bit slots correspond to the valid audio data 506. In contrast, a second frame 508 has a Txready bit 510 set to invalid (e.g., 0) and bits 512 following are unknown (designated by ??? in FIG. 5). While it is generally accepted that the payload data would be 0000 for invalid data (e.g., corresponding to not driving the bus), noise may change these values, and certain proprietary systems may use different values. In any event, since the payload data has been marked as invalid, the receiver will ignore the data. Further, the signal flow diagram 500 illustrates how a frame sent from the audio source is delayed from time T₀, and arrives at time T₁ at the switch 304 (where T₁=T₀+Δ₁, where Δ₁ is the delay over the first segment SOUNDWIRE-XL cable 306), further delayed to time T₂ at arrival at the bridge 312 (where T₂=T₁+Δ₂, where Δ₂ is the delay over the first second segment SOUNDWIRE-XL cable 310) and still further delayed to time T₃ at arrival at a speaker in the headset 316 (where T₃=T₂+Δ₃=T₀+Δ₁+Δ₂+Δ₃, where Δ₃ is the delay over the third segment SOUNDWIRE-XL cable 318). Note that while the frame is being sent from the application processor 302 to the switch 304, another frame is being assembled and readied for transmission. If the audio source (e.g., the application processor 302) has no data to send, that second frame may have a Txready bit set to invalid and a frame like the second frame 508 is sent at time T₁′. Frame 2 propagates across the expanded SOUNDWIRE-XL system 300, arriving at the switch 304 at time T₁′+Δ₁, at the bridge 312 at time T₁′+Δ₁+Δ₂, and at the speaker in the headset 316 at time T₄′=T₁′+Δ₁+Δ₂+Δ₃. Frame 3 propagates across the expanded SOUNDWIRE-XL system 300 beginning at time T₄ and arrives at the speaker at T₄+Δ₁+Δ₂+Δ₃ and so on, with frames continuing to propagate over the expanded SOUNDWIRE-XL system 300. Note that Δ₁+Δ₂+Δ₃ is likely longer than the time between T₀ and T₁′ or the time between T₄ and T₅. However, the concept of continuous processing by the audio source and transmission of frames across the expanded SOUNDWIRE-XL system 300 is illustrated. Likewise, the fact that frames may contain valid audio data so designated and empty bit slots appropriately designated is illustrated. Note further, that while transmission is shown in one direction, there may be two-direction data transmission such as audio collected from a microphone of the headset 316 being sent to the application processor 302.

While the aspect illustrated in FIGS. 4 and 5 is sufficient to preclude the audio sink from processing empty bit slots, this aspect does not take into account the processing capabilities of the audio sink. For example, the audio sink may have limited buffer space for incoming data and may not be able to receive all the data that the audio source sends. However, the audio source does not know that the audio sink is not processing the data and continues to send more data. This arrangement results in dropped audio data and may cause a degraded audio experience.

Another exemplary aspect allows the audio sink to control when the audio sink receives data. This aspect allows the audio sink to evaluate its buffer state and request data only when space is available. This arrangement may eliminate dropped data and improve the audio experience.

In this regard, FIGS. 6 and 7 illustrate an exemplary aspect where the audio sink requests data as the audio sink is capable of processing. In particular, FIG. 6 illustrates a process 600. The process 600 begins with the expanded SOUNDWIRE-XL system 300 performing its initial set-up (block 602). Again, it should be appreciated that while the following example is presented with reference to SOUNDWIRE-XL, other multi-segment audio buses may also benefit from the present disclosure, and the present disclosure is not limited to a SOUNDWIRE-XL system. This set-up may include enumeration, capability inquiry and response, and the like as is well understood. The set-up may further calculate round trip delay between the master (typically the audio source) and slave (typically the audio sink). The audio sink (e.g., the speaker in the headset 316) determines if there is room in its internal buffers (e.g., 324, 326, or 328) for new audio data (block 604). In the case when flow control is needed, the audio sink is likely playing audio according to a desired audio rate, which is generated locally. This desired audio rate is asynchronous to the bus clock. If the answer to block 604 is yes (i.e., the sink has room in the internal buffers), the audio sink populates a frame with an Rxready valid bit and sends (block 606) (i.e., when the older samples in the buffers are played). It should be appreciated that the audio channel rate over the bus is higher than the local playback rate (if not, there will always be an underflow condition). The audio samples stored in the local internal buffers compensate for the time it takes to assert an Rxready bit to the moment a new sample reaches the sink buffer. The frame and Rxready bit are illustrated and described below with reference to FIG. 7. The frame with the Rxready valid bit propagates through the expanded SOUNDWIRE-XL system 300 (or other multi-segment audio bus) to the audio source (block 608). Note that while the first frame is propagating, the audio sink is also evaluating the state of its buffers and determining if the audio sink can receive more data in a subsequent time slot (as denoted by the arrows back to block 604). The audio source receives the frame from the audio sink and processes the Rxready valid bit (block 610). Note that the time elapsed from when the audio sink sends the first frame and receipt of the first frame by the audio source includes latency associated with each segment or cable as well as any internal latency associated with any repeater, bridge, hub, or other intermediate element. The SOUNDWIRE-XL bus turns around, passing control of the bus from the switch 304 to the application processor 302 (block 612). The audio source generates a sample-event and populates the sample-window with valid audio data and sends the valid audio data in the frame (block 614). The frame propagates across the expanded SOUNDWIRE-XL system 300 to the audio sink (block 616). The audio sink processes the valid audio data (block 618). Note that the audio sink knows when to expect to receive the valid audio data based on the round trip delay calculated during set-up as well as any time needed to populate the sample-window. That is, there is an expected amount of predefined delay or latency from the audio sink to the audio source. Likewise, the audio source may take a certain amount of time to populate the sample-window, and there is additional delay or latency as the sample-window propagates back to the audio source. A margin of error factor may be calculated into the round trip delay and added to this time. Based on these factors (and/or other factors), the host may set (or configure) a fixed amount of time that both the audio source and the audio sink know. Based on this time, the audio sink knows when to evaluate the received data for the valid audio bits. As used herein, the received sample-window may be referred to as a signal and more particularly, a corresponding signal in that the signal corresponds to the Rxready bit sent from the audio sink.

In still another exemplary aspect, there may be a predefined fixed delay or latency from the moment the Rxready valid bit is received at the audio source until the valid audio data is sent from the audio source. This configurable fixed delay may take into account any turnaround and/or repeater delay, but may also be larger to compensate for other latencies. Such fixed delay may occur between blocks 610 and 612 (although it is not specifically illustrated). This delay may be based on a physical topology (i.e., the number of intermediate segments between a source and a sink), which provides a deterministic latency value over the link, as every segment uses one turnaround. Taking advantage of this system knowledge may help in predicting when a sample is expected to arrive at the sink side based on the when the sample's delivery was asserted.

With continued reference to FIG. 6, if the answer to block 604 is no, then the audio sink generates a frame with an Rxready invalid bit and sends the frame (block 620). The frame with the Rxready invalid bit propagates to the audio source (block 622). Note that while the frame is propagating, the audio sink is evaluating whether more data can be accommodated and sending the next frame with the appropriate Rxready bit (as denoted by the return to block 604). The audio source receives the frame from the audio sink and processes the Rxready invalid bit (block 624). The SOUNDWIRE-XL bus turns around, passing control of the bus from the switch 304 to the application processor 302 (block 626). The audio source generates a sample-event but leaves the bit slots designated for the audio source empty and sends the sample data in the sample-window with empty bit slots (block 628). The frame propagates across the expanded SOUNDWIRE-XL system 300 to the audio sink (block 630). The audio sink receives the frame and knows that the bit slots do not contain valid data. Accordingly, the audio sink ignores the empty bit slots (block 632). Again as noted above, the audio sink knows when to ignore the empty bit slots based on the round trip delay calculated during set-up.

FIG. 7 illustrates a signal flow diagram 700 showing the frames being generated at the audio sink and sent to the audio source. The first frame is generated and sent at time T₀, arriving at the repeater 308 at time T₁=T₀+δ₁, where δ₁ is the delay of the third segment SOUNDWIRE-XL cable 318, passing through and arriving at the switch 304 at time T₂=T₁+δ₂ (=T₀+δ₁+δ₂) where δ₂ is the delay of the first second segment SOUNDWIRE-XL cable 310, and eventually arriving at the audio source at time T₃=T₂+δ₃ (=T₀+δ₁+δ₂+δ₃), where δ₃ is the delay of the first segment SOUNDWIRE-XL cable 306. While it is expected that Δ₁=δ₃, Δ₂=δ₂, and Δ₃=δ₁, it is possible that delays may be directionally dependent and thus, a different notation is used. Note that the frame that is sent is actually based on a prediction made by the audio sink on a future state of the audio sink. That is, the audio sink knows that it will take some amount of time (i.e., the round trip delay calculated during set-up) for the frame containing the Rxready bit to reach the audio source (e.g., time T₃), it will take some additional amount of time for the bus turnaround (δ₄), and it will take still more time for any frame containing a response to the Rxready bit to propagate through the expanded SOUNDWIRE-XL system 300 back to the audio sink (e.g., T₀+δ₁+δ₂+δ₃+δ₄+Δ₁+Δ₂+Δ₃). Note that this time may be a software control parameter (“n”) counted in sample-intervals or numbers of sample-windows. Meanwhile, the audio sink continues to evaluate expected future states of its buffers and sends a second frame with a second Rxready bit at time T₄. As the audio sink continues to evaluate predicted states of the buffers, and the audio sink sends frames with Rxready bits indicating whether or not the audio source should send data. Because the SOUNDWIRE-XL bus is a bidirectional bus, the frames containing the Rxready bits will be interleaved with the frames coming from the audio source that have valid audio data or empty bit slots depending on earlier sent Rxready bits from the audio sink.

FIG. 7 also illustrates a frame 702 generated by the audio sink. The frame 702 includes an Rxready bit 704. In an exemplary aspect, if the Rxready bit 704 is valid, it has a value of one (1) and if invalid, it has a value of zero (0). In response to receipt of a valid Rxready bit 704, the audio source generates a frame 706 having valid audio data 708 therein. If the audio source receives an Rxready invalid bit, the audio source generates a frame 710 having empty bit slots 712.

It should be appreciated that the precise placement of the Rxready bit 704 and of the valid audio data 708 and the empty bit slots 712 are dictated by what bits within the frame are assigned to a corresponding audio channel as designated by the SOUNDWIRE-XL protocol. Note further, that while the present disclosure has illustrated only one Txready and one Rxready bit being sent per frame, it is possible to concatenate multiple such bits into a single frame and then send subsequent data frames having corresponding valid audio data or empty bit slots according to the instruction of the earlier Txready or Rxready bits. The master and slave may agree to how many bits are sent during respective set-up stages. It is possible that sufficient bits are sent to be termed a “word,” but such nomenclature still falls under the concept of multiple bits.

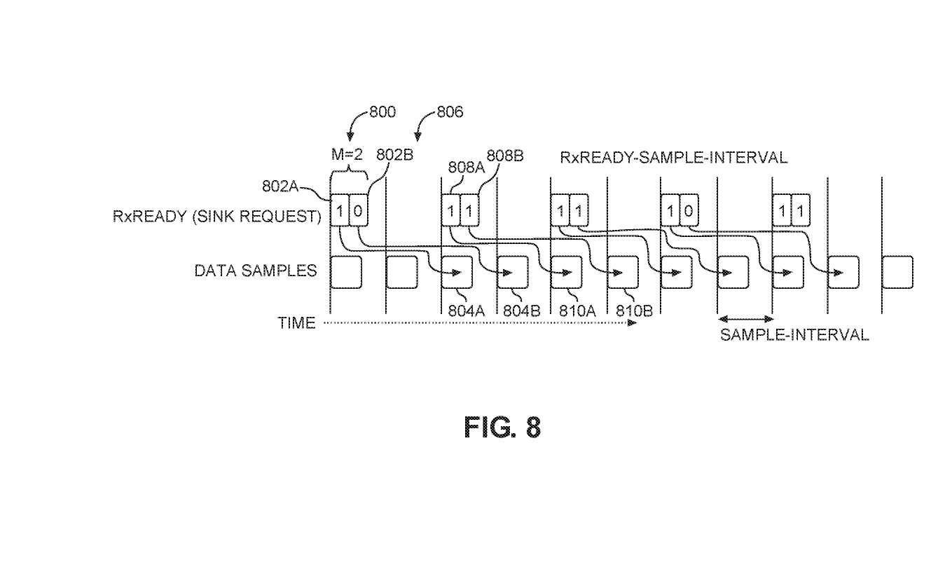

An exemplary situation using two Rxready bits is illustrated in FIG. 8 where a frame 800 from the audio sink includes bits 802A and 802B indicating that two consecutive future frames 804A (e.g., 708) and 804B (e.g., 712) from the audio source are to include valid and invalid bits, respectively. Similarly, after a skipped frame 806, two bits 808A and 808B cause future frames 810A and 810B to both include valid bits. Txready bits would be similar as would be understood.

Note further, that while the above discussion has contemplated control either from the audio source or the audio sink, the present disclosure also contemplates shared control. In one exemplary aspect, the audio source force feeds the audio sink until the audio sink sends an Rxready invalid bit indicating that the audio sink's buffers are full. In another exemplary aspect, the audio source responds to Rxready bits by providing valid audio data until such time as the audio source has no data, at which time, the audio source sends a Txready invalid bit so that the audio sink knows to ignore the empty bit slots. In still another aspect, the audio source always sends a Txready bit with any frame and the audio sink always sends an Rxready bit with any frame. Still other shared control arrangements are possible.

The flow control protocol for an audio bus according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

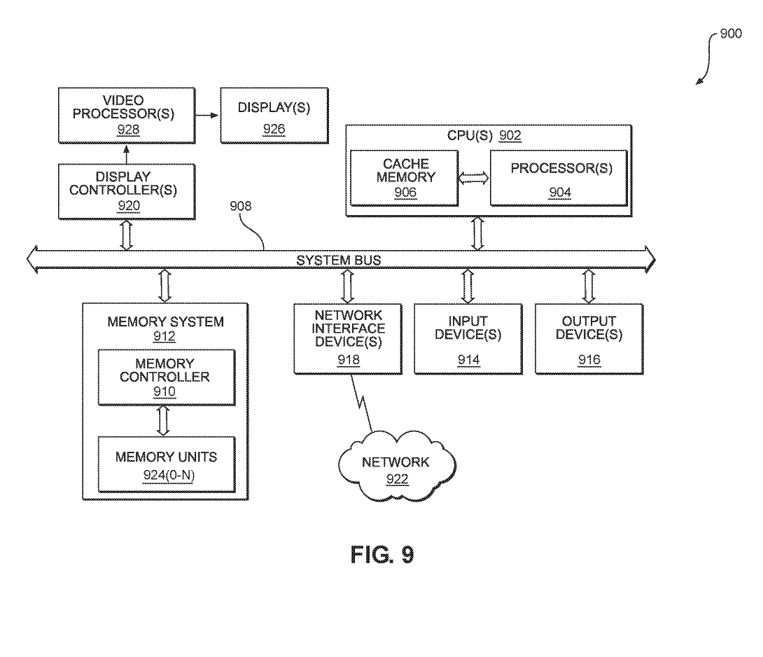

In this regard, FIG. 9 illustrates an example of a processor-based system 900 that can employ the expanded SOUNDWIRE-XL system 300 illustrated in FIG. 3. In this example, the processor-based system 900 includes one or more central processing units (CPUs) 902, each including one or more processors 904. The CPU(s) 902 may be the application processor 302. The CPU(s) 902 may have cache memory 906 coupled to the processor(s) 904 for rapid access to temporarily stored data. The CPU(s) 902 is coupled to a system bus 908 and can intercouple master and slave devices included in the processor-based system 900. As is well known, the CPU(s) 902 communicates with these other devices by exchanging address, control, and data information over the system bus 908. For example, the CPU(s) 902 can communicate bus transaction requests to a memory controller 910 as an example of a slave device. Although not illustrated in FIG. 9, multiple system buses 908 could be provided, wherein each system bus 908 constitutes a different fabric.

Other master and slave devices can be connected to the system bus 908. As illustrated in FIG. 9, these devices can include a memory system 912, one or more input devices 914, one or more output devices 916, one or more network interface devices 918, and one or more display controllers 920, as examples. The input device(s) 914 can include any type of input device, including, but not limited to, input keys, switches, voice processors, etc. The output device(s) 916 can include any type of output device, including, but not limited to, audio, video, other visual indicators, etc. The network interface device(s) 918 can be any devices configured to allow exchange of data to and from a network 922. The network 922 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 918 can be configured to support any type of communications protocol desired. The memory system 912 can include one or more memory units 924(0-N).

The CPU(s) 902 may also be configured to access the display controller(s) 920 over the system bus 908 to control information sent to one or more displays 926. The display controller(s) 920 sends information to the display(s) 926 to be displayed via one or more video processors 928, which process the information to be displayed into a format suitable for the display(s) 926. The display(s) 926 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method of controlling a SOUNDWIRE-XL bus, comprising:
at an audio source, populating a signal with at least one Txready bit;
when the at least one Txready bit is valid, populating the signal with valid audio data at a corresponding location;
when the at least one Txready bit is invalid, leaving the corresponding location empty; and
sending the signal over a SOUNDWIRE-XL bus.

2. The method of claim 1, further comprising determining if the audio source has audio data to send.

3. The method of claim 2, further comprising setting the at least one Txready bit as valid responsive to determining that the audio source has audio data to send.

4. The method of claim 2, further comprising setting the at least one Txready bit as invalid responsive to determining that the audio source does not have audio data to send.

5. The method of claim 1, wherein populating the signal with the at least one Txready bit comprises populating the signal with a plurality of Txready bits.

6. The method of claim 1, further comprising sending a second signal with a second Txready bit subsequently to sending the signal.

7. An audio source comprising:
a downstream-facing interface configured to couple to a SOUNDWIRE-XL audio bus; and
a control system configured to:
populate a signal with at least one Txready bit;
when the at least one Txready bit is valid, populate the signal with valid audio data at a corresponding location;
when the at least one Txready bit is invalid, leave the corresponding location empty; and
send the signal over the SOUNDWIRE-XL audio bus.

8. An audio source comprising:
a downstream-facing interface configured to couple to a multi-segment audio bus; and
a control system configured to:
populate a signal with at least one Txready bit;
when the at least one Txready bit is valid, populate the signal with valid audio data at a corresponding location;
when the at least one Txready bit is invalid, leave the corresponding location empty; and
send the signal over the multi-segment audio bus.

9. A method of controlling a multi-segment audio bus, comprising:
at an audio source, populating a signal with at least one Txready bit;
when the at least one Txready bit is valid, populating the signal with valid audio data at a corresponding location;
when the at least one Txready bit is invalid, leaving the corresponding location empty; and
sending the signal over a multi-segment audio bus.

10. A method of controlling a SOUNDWIRE-XL bus, comprising:
at an audio sink, receiving a signal from a SOUNDWIRE-XL bus;
evaluating a Txready bit within the signal;
when the Txready bit is valid, reading audio data from corresponding bit slots in the signal; and
when the Txready bit is invalid, ignoring data from the corresponding bit slots.

11. The method of claim 10, wherein evaluating the Txready bit comprises evaluating a plurality of Txready bits within the signal.

12. The method of claim 11, further comprising, responsive to the plurality of Txready bits, reading audio data from future frames based on valid Txready bits and ignoring data from future frames based on invalid Txready bits.

13. An audio sink comprising:
an upstream-facing interface configured to be coupled to a SOUNDWIRE-XL bus; and
a control system configured to:
evaluate a Txready bit within a signal received from the SOUNDWIRE-XL bus;
when the Txready bit is valid, read audio data from corresponding bit slots in the signal; and
when the Txready bit is invalid, ignore data from the corresponding bit slots.

14. An audio sink comprising:
an upstream-facing interface configured to be coupled to a multi-segment audio bus; and
a control system configured to:
evaluate a Txready bit within a signal received from the multi-segment audio bus;
when the Txready bit is valid, read audio data from corresponding bit slots in the signal; and
when the Txready bit is invalid, ignore data from the corresponding bit slots.

15. A method of controlling a multi-segment audio bus, comprising:
at an audio sink, receiving a signal from a multi-segment audio bus;
evaluating a Txready bit within the signal;
when the Txready bit is valid, reading audio data from corresponding bit slots in the signal; and
when the Txready bit is invalid, ignoring data from the corresponding bit slots.

16. A method of controlling a SOUNDWIRE-XL bus, comprising:
determining if an audio sink will have room for data;
sending an Rxready bit to an audio source where the Rxready bit is valid if there is room for the data and invalid if there is not room for the data;
receiving a corresponding signal from the audio source;
when the audio sink sends an Rxready valid bit, reading audio data from the corresponding signal; and
when the audio sink sends an Rxready invalid bit, disregarding the data from the corresponding signal.

17. The method of claim 16, further comprising calculating an expected delay between sending the Rxready bit and receiving the corresponding signal.

18. An audio sink comprising:
an upstream-facing interface configured to be coupled to a SOUNDWIRE-XL bus;
a buffer; and
a control system configured to:
determine if the buffer will have room for data;
send an Rxready bit to an audio source where the Rxready bit is valid if there is room for the data and invalid if there is not room for the data;
receive a corresponding signal from the audio source;
when the audio sink sends an Rxready valid bit, read audio data from the corresponding signal; and
when the audio sink sends an Rxready invalid bit, disregard the data from the corresponding signal.

19. A method of controlling a SOUNDWIRE-XL bus, comprising:
at an audio source, receiving a signal from an audio sink;
reading an Rxready bit in the signal from the audio sink;
when the Rxready bit is valid, populating a second signal with valid data and sending the second signal to the audio sink; and
when the Rxready bit is invalid, sending the second signal with empty bit slots instead of the valid data to the audio sink.

20. A method of controlling a multi-segment audio bus, comprising:
at an audio source, receiving a signal from an audio sink across a multi-segment audio bus;
reading an Rxready bit in the signal from the audio sink;
when the Rxready bit is valid, populating a second signal with valid data and sending the second signal to the audio sink across the multi-segment audio bus; and
when the Rxready bit is invalid, sending the second signal with empty bit slots instead of the valid data to the audio sink.

21. An audio source comprising:
a downstream-facing interface configured to couple to a multi-segment audio bus; and
a control system configured to:
receive a signal from an audio sink across the multi-segment audio bus;
read an Rxready bit in the signal from the audio sink;
when the Rxready bit is valid, populate a second signal with valid data and send the second signal to the audio sink across the multi-segment audio bus; and
when the Rxready bit is invalid, send the second signal with empty bit slots instead of the valid data to the audio sink.

22. An audio source comprising:
a downstream-facing interface configured to couple to a SOUNDWIRE-XL bus; and
a control system configured to:
receive a signal from an audio sink across the SOUNDWIRE-XL bus;
read an Rxready bit in the signal from the audio sink;
when the Rxready bit is valid, populate a second signal with valid data and send the second signal to the audio sink across the SOUNDWIRE-XL bus; and
when the Rxready bit is invalid, send the second signal with empty bit slots instead of the valid data to the audio sink.

23. The audio source of claim 22 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

24. An audio sink comprising:
an upstream-facing interface configured to be coupled to a multi-segment audio bus;
a buffer; and
a control system configured to:
determine if the buffer will have room for data;
send an Rxready bit to an audio source where the Rxready bit is valid if there is room for the data and invalid if there is not room for the data;
receive a corresponding signal from the audio source;
when the audio sink sends an Rxready valid bit, read audio data from the corresponding signal; and
when the audio sink sends an Rxready invalid bit, disregard the data from the corresponding signal.

25. A method of controlling a multi-segment audio bus, comprising:
determining if an audio sink will have room for data;
sending an Rxready bit to an audio source where the Rxready bit is valid if there is room for the data and invalid if there is not room for the data;
receiving a corresponding signal from the audio source;
when the audio sink sends an Rxready valid bit, reading audio data from the corresponding signal; and
when the audio sink sends an Rxready invalid bit, disregarding the data from the corresponding signal.
